(19) United States
(12) Patent Application Publication
(10) Pub. No.: US 2005/0002643 A1
(43) Pub. Date: Jan. 6, 2005

(54) Audio/video editing apparatus

(76) Inventor: Jason W. Smith, Hoboken, NJ (US)

Correspondence Address: FROMMER LAWRENCE & HAUG, 745 FIFTH AVENUE- 10TH FL., NEW YORK, NY, 10151, US

(21) Appl. No.: 10/690,081

(22) Filed: Oct. 21, 2003

Related U.S. Application Data
(60) Provisional application No. 60/419,765, filed on Oct. 21, 2002.

(51) Int. Cl. H04N 5/93; G11B 27/00

(52) U.S. Cl. 386/52; 386/55

(57) ABSTRACT

The present invention relates to a portable instrument for editing audio/video clips in real time. The instrument includes a processor for processing audio/video clips by applying a special effect to the clip. The instrument also includes a memory for storing the audio/video clips and also be selected to be applied to the selected to be reproduced and a special effect may also be selected to be applied to the selected clip. As the special effect is applied to the clip, the resultant clip is outputted in real time.

### CROSS-REFERENCE TO RELATED APPLICATIONS

This application claims benefit of U.S. Provisional Patent Application Ser. No. 60/419,765 filed Oct. 21, 2002, entitled “Viditar: Electronic video and audio instrument system for performance, sequencing and editing system with digital and non-digital interface”, the entire contents of which are incorporated by reference.

### FIELD OF THE INVENTION

The present invention is directed to an audio/video instrument usable in live performances. More specifically, the present invention is directed to a audio/video editing instrument for editing audio/video in real time while performing live in a concert type setting or the like. The audio/video instrument would benefit artists, performers, singers, musicians, filmmakers, video editors, presenters, speaker, and producers of multimedia content or the like.

### BACKGROUD OF THE INVENTION

During live performances, many performers augment their show using audio/visual content. Such content is traditionally processed and recorded in a studio using large, bulky equipment. A user mixes audio and video data, adds special effects to the data, and then records the processed data to be reproduced at a later time.

However, the traditional methods provide for many drawbacks. For instance, due to the size of traditional equipment, the equipment is not easily transported from one location to another. Therefore, most of the audio/video processing has to be done at the studio.

Additionally, since the audio/video is processed beforehand, a performer can not adjust the special effects during a performance. For instance, the audience may prefer one special effect over another. However, because the audio/video was pre-recorded, the performer can not use that special effect or any other special effects when he/she desires. As such, the audience may enjoy the performance at a lesser degree.

To the extent that live video editing is performed, the large size of the traditional editing equipment typically requires the video editor to be located away from the performance, and therefore the editor cannot contribute to the show as an on stage performer.

Furthermore, most musical instruments used during a live performance allow a user to customize his/her performance while on stage. However, such musical instruments do not include access to a variety of multimedia contents.

### SUMMARY OF THE INVENTION

Having noticed the above described drawbacks with regard to audio/video content being displayed during live performances, the inventors of the present application have designed an instrument for processing audio/video data during a live performance in real time.

In a present embodiment of the invention, the instrument comprises a processing means for processing audio/video data, storage means for storing audio/video data and special effects, receiving means for receiving audio/video data, first selecting means for selecting audio/video data to be reproduced, second selecting means for selecting a special effect to be applied to the selected audio/video data, and a outputting means for outputting the processed audio/video data in real time.

The instrument may further comprise a transmitting means to transmit the processed audio/video data to a remote location. The transmitting means may utilize a wireless transmitter, firewire (IEEE-1394), a serial connection, Ethernet (IEEE-802.3), or the like.

Additionally, the receiving means may utilize a wireless transmitter, firewire (IEEE-1394), a serial connection, Ethernet (IEEE-802.3), or the like.

Furthermore, the instrument may be shaped as any number of traditional instruments such as a guitar, or the like.

In another embodiment of the invention, there is a method for the instrument of the present invention comprising the steps of selecting an audio or video clip, selecting a special effect, applying the special effect to the selected clip with, and outputting the resultant clip.

In yet another embodiment of the present invention, there is a computer readable medium for storing a program to be executed by a computer where the program includes the steps of selecting an audio or video clip, selecting a special effect, applying the special effect to the selected clip with, and outputting the resultant clip.

### BRIEF DESRIPTION OF THE DRAWINGS

FIG. 1 is a block diagram of the instrument according to the present invention.

FIG. 2 is a flow diagram of describing a method of using the instrument according to the present invention.

FIG. 3 is an example of the instrument shaped as a guitar.

### DETAILED DESCRIPTION OF THE INVENTION

The present invention was designed to bring spontaneity and instant feedback to the act of mixing and playing multimedia. The present invention creates compositions by giving control to the user and or users. The performance instrument is designed and engineered to control video clips and audio clips in real-time using traditional music gestures to control the software(s) playing of content. This instrument can be played like a guitar or portable synthesizer. It may or may not include momentary push buttons, vertical slide potentiometers and toggle switches, all which control and trigger video clips from a QuickTime video database and or software(s).

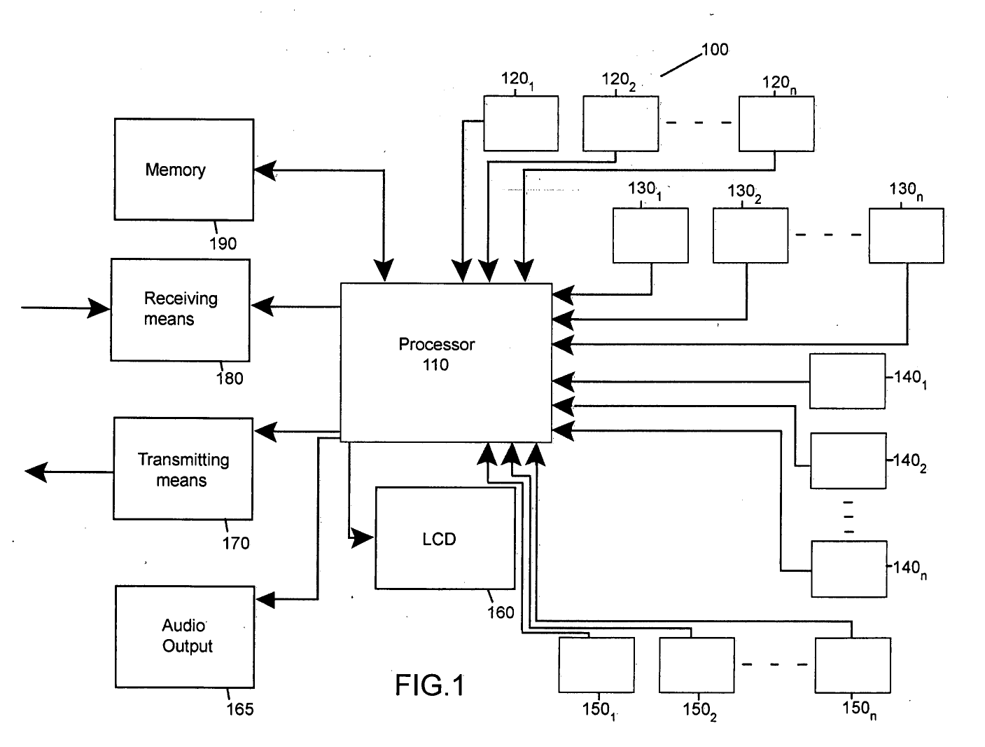

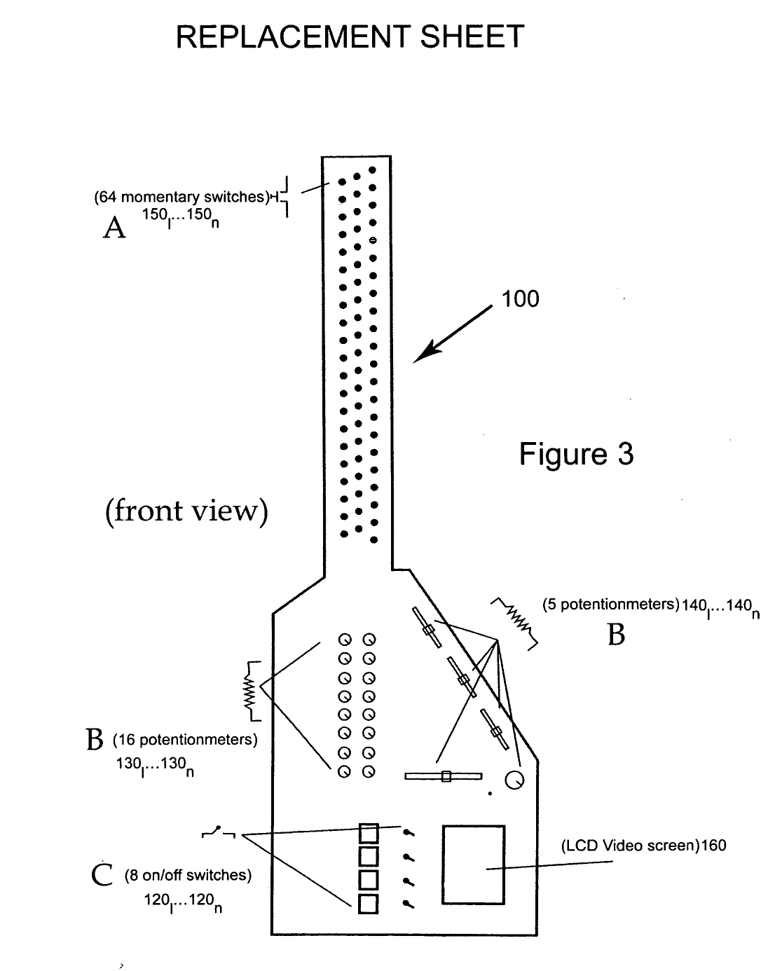

FIG. 1 depicts a general block diagram of the present invention and FIG. 3 depicts these block features in place on an actual guitar shaped instrument constructed in accordance with an example, but preferred embodiment of the invention. The instrument 100 includes a processor 110 for processing the video data. The processor 110 receives audio/video data from either memory 190 or receiving means 180. Memory 190 can be a flash memory, random access memory, read only memory, hard drive, optical disc, tape memory, or the like. The receiving means 180 may utilize a may utilize a wireless receiver, firewire (IEEE-1394), a serial connection, Ethernet (IEEE-802.3), or the like. The receiving means 180 may be connected to an external memory, computer, or a video camera

Switches 150₁ to 150ₙ are momentary switches used to select audio/video clips from memory 190. Each momentary switch is associated with a particular audio or video clip so that upon activation, a particular audio or video clip is selected to be reproduced. The selected clip is obtained from either receiving means 180 or memory 190 by the processor 110 to be processed and displayed.

While the clips are displayed, a user can apply special effects to the clips using on/off switches 120₁ to 120ₙ and potentiometers 130₁ to 130ₙ and 140₁ to 140ₙ in real time. Each on/off switch and potentiometer is associated with a special effect. The special effects include, but are not limited to, speed, size, position, direction, rotation, selection, real-time effects, time, volume, morphing between one clip and another clip. By adjusting the potentiometers and the on/off switches, the selected clips can be altered in real time making the performance interactive. For instance, if the audience reacts better to one special effect than another, a performer has the ability to introduce that special effect at any time he/she pleases. As such, each performance can be customized for its audience. The special effects are stored in memory 190 and are retrieved upon activation of the corresponding switches or potentiometers.

After a video clip is processed by processor 110, the clip is displayed on a liquid crystal display (LCD) 160. Although, the present invention utilizes an LCD, any device capable of displaying video data may be utilized. Audio clips processed by processor 110 are transferred to an audio output 165 such as a speaker.

Instead of outputting the processed audio or video data on the audio output 165 or display 160 respectively, a user may wish to transmit such data to a remote location, such as a larger display screen or an external audio system. Accordingly, instrument 100 may also include a transmitting means 170 to transmit the data to an external source. The transmitting means 170 may utilize a wireless transmitter, firewire (IEEE-1394), a serial connection, Ethernet (IEEE-802.3), or the like.

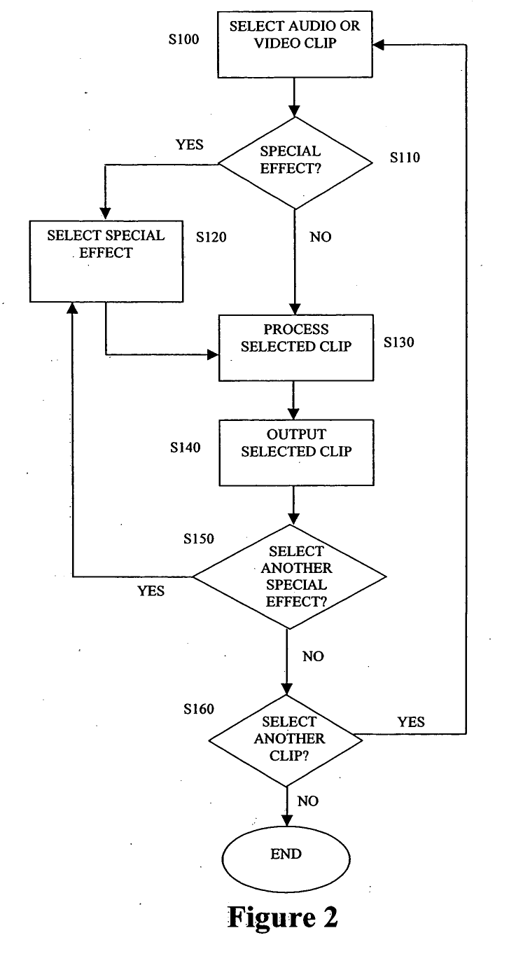

FIG. 2 depicts a method for processing a clip according to the present invention. In step S100, a user selects either an audio clip or a video clip using the instrument 100. Then instrument 100 makes a determination as to whether or not a special effect is to be applied to the clip at step S 110. If no special effect is selected using the on/off switches or potentiometers, then the process continues to step S130. If the instrument determines that a special effect is desired, then the process goes to step S120 where a special effect is selected. In step 130, the selected clip, and if chosen, the selected special effect is processed and then outputted in step S140. After which, a determination is made if another special effect should be applied to the selected clip. If so, the method returns to step S120 to select another special effect. Otherwise, the instrument makes a determination if the user wishes to select another clip at step S160. If yes, the method returns to step S100. If no, the processing for the selected clip ends when the clip is finished reproducing.

The above-described steps may also be incorporated into a program to be executed by a computer. Such program may reside in memory 190 a memory contained within the processor, or another computer readable memory.

It should be readily appreciated by one skilled in the art that the present invention is not limited to the embodiments described above. For instance, although FIG. 3 depicts the instrument as a guitar, the instrument may be shaped in any form the user desires. Also the number of switches and potentiometers shown in FIG. 3 is merely an example. Any number of or combination of such switches and potentiometers may be used in conjunction with the present invention.

Although preferred embodiments of the present invention and modifications thereof have been described in detail herein, it is to be understood that this invention is not limited to these embodiments and modifications, and that other modifications and variations may be effected by one skilled in the art without departing from the spirit and scope of the invention as defined by the appended claims.

1. A portable instrument for editing audio/video clips in real time, said instrument comprising:
processing means for processing said audio/video clips;
storage means for storing a plurality of said audio/video clips, and a plurality of special effects;
first selecting means for selecting a clip from said plurality of audio/video clip;
second selecting means for selecting a special effect from said plurality of special effects; and
outputting means for outputting the processed audio/video clips in real time,
wherein said processing means applies said selected special effect to said audio/video clips.

2. The portable instrument according to claim 1 further comprising a receiving means for receiving said audio/video clips.

3. The portable instrument according to claim 2 wherein said receiving means is a wireless receiving means.

4. The portable instrument according to claim 1 further comprising a transmitting means for transmitting the processed audio/video clips.

5. The portable instrument according to claim 4 wherein said transmitting means is a wireless transmitting means.

6. A method of controlling a portable instrument for editing an audio/video clip in real time, said method comprising the steps of:
receiving a plurality of said audio/video clips and a plurality of special effects;
storing said plurality of said audio/video clips and said plurality of special effects;
selecting said audio/video clip from said plurality of audio/video clips;
selecting a special effect from said plurality of special effects;
applying the selected special effect to the selected audio/video clip to generate a resultant audio/video clip; and
outputting said resultant audio/video clip.

7. A computer readable medium having a computer readable program, said program comprising the steps of:
receiving a plurality of said audio/video clips and a plurality of special effects;
storing said plurality of said audio/video clips and said plurality of special effects;
selecting said audio/video clip from said plurality of audio/video clips;
selecting a special effect from said plurality of special effects;
applying the selected special effect to the selected audio/video clip to generate a resultant audio/video clip: and
outputting said resultant audio/video clip.
